(19) United States
(12) Patent Application Publication
(10) Pub. No.: US 2003/0027921 A1
(43) Pub. Date: Feb. 6, 2003

(54) Nonaqueous thermosetting two-component coating composition

(75) Inventors: Peter Speier, Marl (DE); Friedrich Plogmann, Castrop-Rauxel (DE); Rainer Lomoelder, Muenster (DE); Dirk Hoppe, Nottuln (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, Duesseldorf (DE)

(21) Appl. No.: 10/189,484

(22) Filed: Jul. 8, 2002

(30) Foreign Application Priority Data
Jul. 6, 2001 (DE) 101 32 938.5

(51) Int. Cl. C08K 3/00; C08F 20/00

(52) U.S. Cl. 524/589; 525/440

(57) ABSTRACT

A nonaqueous thermosetting two-component coating composition comprising

A) a solvent-containing polyol component and

B) a crosslinker component, comprising at least one aliphatic and/or cycloaliphatic polyisocyanate having an NCO functionality of 2-6, from 0.1 to 95 mol % of the originally present free isocyanate groups of the polyisocyanate having undergone reaction with N,N-bis(3-trialkoxysilylpropyl)amines, in a weight ratio A) to B) of from 6:1 to 1:2, based on nonvolatile organic constituents.

### BACKGROUND OF THE INVENTION

1. Field of the Invention

The present invention relates to a nonaqueous thermosetting two-component coating composition featuring an improved balance between scratch resistance and resistance to environmental effects, particularly to acid rain.

2. Description of the Background

Two-component polyurethane (PU) coating compositions are used for topcoating in the automobile industry owing to their effective resistance to environmental effects, particularly acid rain, in comparison with conventional coating systems which crosslink using amino resin (W. Wieczorrek in: Stoye/Freitag, Lackharze, p. 215 ff., C. Hanser Verlag, 1996; J. W. Holubka et al., J. Coat. Techn. Vol. 72, No. 901, p. 77, 2000). OH-functional poly(meth)acrylate resins and polyisocyanates based on hexamethylene diisocyanate (HDI) are generally used in this case. The effective resistance to environmental effects may be significantly improved further by the partial use of IPDI (isophorone diisocyanate) polyisocyanates (WO 93/05090). A disadvantage with such modifications, however, is the marked reduction in topcoat scratch resistance as compared with straight HDI polyisocyanate crosslinking (Industrie Lackierbetrieb, 61, p. 30, 1993).

Reaction products of polyisocyanates with secondary 3-aminopropyltrialkoxysilanes are known. For instance, 3-aminopropyltrialkoxysilanes modified with maleic or fumaric ester are reacted with isocyanate prepolymers in order to enhance the adhesion of corresponding coating systems or sealing compounds and to reduce the disadvantageous evolution of CO₂ (EP 596 360, U.S. Pat. No. 6,005,047). Isocyanate adducts of this kind are also described for the preparation of aqueous PU dispersions (EP 924 231) or as curing components for aqueous two-component (2K) PU systems (EP 872 499, EP 949 284). In the great majority of cases, the coatings are cured at ambient temperature or slightly elevated temperature under the effect of moisture.

EP 549 643, WO 92/11327, WO 92/11328, and U.S. Pat. No. 5,225,248 describe the use of resins containing silane groups in nonaqueous thermosetting clearcoat materials for automotive OEM finishes for the purpose of improving the resistance properties, particularly the resistance to acid rain. Here, clearcoat materials based on poly(meth)acrylate resins containing silane groups, poly(meth)acrylate resins containing hydroxyl groups, and, in general, amino resin crosslinkers are used. Although such clearcoat materials are commonly regarded as being resistant to acid, they in fact prove greatly inferior to the 2K PU coating materials in this respect (J. W. Holubka et al., J. Coat. Techn. Vol. 72, No. 901, p. 77, 2000).

Against the background of rising quality requirements imposed on automotive OEM finishes, an improvement is aimed at in the requisite properties.

### SUMMARY OF THE INVENTION

It is an object of the present invention to find a coating composition which leads in the cured state to coatings featuring an improved balance between resistance to environmental effects and high mechanical resistance, particularly scratch resistance.

This object has been achieved by the two-component coating composition of the invention.

The invention provides nonaqueous thermosetting two-component coating compositions comprising

A) a solvent-containing polyol component

B) a crosslinker component,

comprising at least one aliphatic and/or cycloaliphatic polyisocyanate having an NCO functionality of 2-6, from 0.1 to 95 mol % of the originally present free isocyanate groups of the polyisocyanate having undergone reaction with N,N-bis(3-trialkoxysilylpropyl)amines, in a weight ratio A) to B) of from 6:1 to 1:2, based on the nonvolatile organic constituents.

The achievement of the object was surprising as modification with N,N-bis(3-trialkoxysilylpropyl)amines could not have been expected to improve the resistance properties of nonaqueous 2K PU systems.

### DETAILED DESCRIPTION OF THE INVENTION

In principle, all polyols containing more than two OH groups are suitable for use as polyol component A.

Particularly suitable polyol components A) include hydroxyl-containing (meth)acrylic copolymers, saturated polyester polyols, polycarbonate diols, polyether polyols, or polyols containing urethane groups and ester groups, alone or in mixtures.

The hydroxyl-containing (meth)acrylic copolymers include resins having a monomer composition as described, for example, in WO 93/15849 (p. 8, line 25 to p. 10, line 5), or else in DE 195 29 124. The acid number of the (meth)acrylic copolymer, adjustable by proportional use of (meth)acrylic acid as a monomer, should be 0-30, preferably 3-15. The number-average molar weight (determined by gel permeation chromatography against a polystyrene standard) of the (meth)acrylic copolymer is preferably 2 000-20 000 g/mol, the glass transition temperature preferably from −40° C. to +60° C. The hydroxyl content of the (meth)acrylic copolymers for use in accordance with the invention, adjustable by proportional use of hydroxyalkyl (meth)acrylates, is preferably 70-250 mg KOH/g, with particular preference 90-190 mg KOH/g.

Polyester polyols suitable in accordance with the invention are resins having a monomer composition comprising dicarboxylic and polycarboxylic acids and diols and polyols, such as are described, for example, in Stoye/Freitag, Lackharze, C. Hanser Verlag, 1996, p.49 or else in WO 93/15849. Applicable polyester polyols also include polyadducts of caprolactone and low molecular mass diols and triols, as available, for example, under the designation TONE (Union Carbide Corp.) or CAPA (Solvay/interox). The arithmetic number-average molar weight is preferably 500-5 000 g/mol, with particular preference 800-3 000 g/mol, the average functionality 2.0-4.0, preferably 2.0-3.5.

Polyols containing urethane groups and ester groups and suitable for use in accordance with the invention include those as described in EP 140 186. Preference is given to polyols containing urethane groups and ester groups and prepared using HDI, IPDI, trimethylhexamethylene diisocyanate (TMDI) or (H₁₂-MDI). The number average molar weight is preferably 500-2 000 g/mol, the average functionality 2.0-3.5.

The crosslinker component B) is composed of at least one aliphatic and/or cycloaliphatic polyisocyanate having an NCO functionality of 2-6, from 0.1 to 95 mol % of the originally present free isocyanate groups of the polyisocyanate having undergone reaction with N,N-bis(3-trialkoxysilylpropyl)amines.

The polyisocyanate of component B) is based on hexamethylene diisocyanate (HDI), isophorone diisocyanate (IPDI), bis(4-isocyanatocyclohexyl)methane, (H₁₂-MDI), tetramethylxylylene diisocyanate (TMXDI), 1,3-bis(isocyanatomethyl)cyclohexane (1,3-H-XDI), 2,2,4- and 2,4,4-trimethyl-1,6-diisocyanatohexane (TMDI), 2-methylpentene 1,5-diisocyanate (MPDI), norbornyl diisocyanate (NBDI), lysine triisocyanate (LTI) or 4-isocyanatomethyl-1,8-octamethylene diisocyanate (NTI), or mixtures of these diisocyanates, and has an average NCO functionality of 2.0-6.0.

In the case of a functionality of more than two it is preferred to use polyisocyanates—alone or in mixtures—as prepared by trimerization, dimerization, urethane formation, biuret formation or allophanate formation, and also blends thereof with monomers. Polyisocyanates or polyisocyanate/monomer mixtures of this kind may where appropriate be additionally chain-extended or branched using difunctional or polyfunctional, H-acidic components such as diols or polyols and/or diamines or polyamines, for example.

For the aliphatic and/or cycloaliphatic crosslinker component B), the polyisocyanates are modified by reaction with N,N-bis(3-trialkoxysilylpropyl)amines preferably having the general formula I

NH((CH₂)₃—Si(OR¹OR²OR³))₂ (I)

in which R¹, R² and R³ simultaneously or independently of one another are an alkyl group or isoalkyl group having 1-8 carbon atoms.

Preferred compounds are the following:

N,N-bis(3-trimethoxysilylpropyl)amine

N,N-bis(3-triethoxysilylpropyl)amine

N,N-bis(3-triisopropoxysilylpropyl)amine.

A further preparation variant of the crosslinking component B) comprises the partial reaction of monomeric diisocyanates with the above compounds of the formula I and subsequent conversion into the polyisocyanate by trimerization, dimerization, urethane formation, biuret formation or allophanate formation, and with subsequent distillative removal of residual monomers (where necessary). Mixtures of unmodified polyisocyanates and fully reacted polyisocyanates are also in accordance with the invention.

The reaction takes place in liquid phase, i.e., where appropriate, with the use of aprotic solvents which are customary in PU technology, at temperatures below 130° C., using catalysts and/or stabilizers where appropriate.

The nonaqueous 2K coating composition of the invention generally comprises solvents known in coatings technology, examples being ketones, esters or aromatics, and auxiliaries such as stabilizers, including light stabilizers, catalysts, leveling agents or rheological agents, such as those known as sag control agents for example, microgels or pyrogenic silica in typical concentrations.

Particularly suitable catalysts are those which are established in the field of PU technology, such as organic Sn(IV), Sn(II), Zn, and Bi compounds or tertiary amines (PU catalysts).

Suitable catalysts also include sulfonic acid-based catalysts in latent form, as amine-neutralized components, or in the form of a covalent adduct with epoxide-containing compounds, such as described in particular in DE-A 23 56 768.

It is also applicable to use catalysts which accelerate the reaction of the alkoxysilane groups with the OH groups of the resin components of the invention, or the hydrolysis. In addition to the catalysts described above, these are, in particular, aluminum titanates and also aluminum chelates and zirconium chelates.

With particular advantage, use is made of combinations of PU catalysts and blocked, sulfonic acid-based catalysts and/or aluminum titanates and also aluminum chelates and zirconium chelates. The catalyst concentrations are 0.01-0.5% by weight of PU catalyst and 0.1-7% by weight of the above catalysts, based on nonvolatile organic constituents. This embodiment is a particularly preferred variant of the coating compositions of the invention.

Where necessary, organic or inorganic color and/or effect pigments customary in coatings technology may also be incorporated into component A).

The weight ratio of components A) and B) in the coating composition of the invention is from 6:1 to 1:2, based on nonvolatile organic constituents.

Immediately prior to processing, components A) and B) are mixed until a homogeneous solution is formed. On an industrial scale, mixing may also take place advantageously in units known as two-component units.

The coating composition of the invention may be applied by known techniques such as spraying, dipping, rolling or doctor blade coating. The substrate to be coated may already have been provided with other coating films. The coating composition of the invention is particularly suitable for use as a clearcoat material, which is applied by a technique known as wet-on-wet to one or more basecoat films, and these films are then cured together.

Curing of the coating composition of the invention takes place in the temperature range of 100-180° C.

The coating compositions of the invention find application in the production of clearcoats or topcoats in the automotive OEM sector.

Having generally described this invention, a further understanding can be obtained by reference to certain specific examples which are provided herein for purposes of illustration only and are not intended to be limiting unless otherwise specified.

### EXAMPLES

Unless stated otherwise, amounts are by weight.

I. Preparation of the Crosslinker Component B1:

73.5 parts by weight of VESTANAT T 1890 L (70% strength solution of IPDI polyisocyanate (isocyanurate) in butyl acetate/Solvesso 100=½, Degussa AG) and 7.9 parts by weight of a ½ butyl acetate/Solvesso 100 solvent mixture are initially charged. With cooling, 17.9 parts by weight of N,N-bis(3-triethoxysilylpropyl)amine (DYNASYLAN 1122, Degussa AG) are added dropwise over 1 h, the temperature not exceeding 30° C. Following complete addition of the silane, the mixture is stirred at ambient temperature for 1 h and 0.7 part by weight of Irganox 1135 is added. The solids content of the solution is 70%, its free NCO content 7.1%, and its viscosity (DIN 53019, 23° C.) 400 mPas.

The degree of silanization is 20%, based on the initial NCO groups.

II. Preparation of the Crosslinker Component B2:

55.2 parts by weight of DESMODUR N 3300 (HDI polyisocyanate (isocyanurate), Bayer AG) and 20.0 parts by weight of Solvesso 100 are initially charged. With cooling, 24.1 parts by weight of N,N-bis(3-triethoxysilylpropyl)amine (DYNASYLAN 1122, Degussa AG) are added dropwise over 1 h, the temperature not exceeding 30° C. Following complete addition of the silane, the mixture is stirred at ambient temperature for 1 h and 0.7 part by weight of Irganox 1135 is added. The solids content of the solution is 80%, its free NCO content 9.5%, and its viscosity (DIN 53019, 23° C.) 300 mPas.

The degree of silanization is 20%, based on the initial NCO groups.

III. Preparation of the Crosslinker Component B3:

58.5 parts by weight of DESMODUR N 3300 (HDI polyisocyanate (isocyanurate), Bayer AG) and 20.0 parts by weight of Solvesso 100 are initially charged. With cooling, 20.7 parts by weight of N,N-bis(3-trimethoxysilylpropyl)amine (SILQUEST 1170, C. K. Witco) are added dropwise over 1 h, the temperature not exceeding 30° C. Following complete addition of the silane, the mixture is stirred at ambient temperature for 1 h and 0.7 part by weight of Irganox 1135 is added. The solids content of the solution is 80%, its free NCO content 10.2%, and its viscosity (DIN 53019, 23° C.) 360 mPas.

The degree of silanization is 20%, based on the initial NCO groups.

IV. Preparation of the 2K Coating Compositions of the Invention

Table 1 lists the compositions of the 2K coating compositions of the invention, Examples 1-5, and of the comparative examples, Comparative Example 1 and Comparative Example 2.

For the preparation, first of all, all of the ingredients with the exception of the polyisocyanates were mixed very intimately until homogenization was complete. Immediately before processing, the aforeprepared mixture and the crosslinker component B were mixed until homogeneous.

When using two-component units, fractions of the solvents were used to predilute the polyisocyanate in order to set favorable viscosities of each component and favorable mixing proportions.

TABLE 1
two-component clearcoat compositions

| | Comparative | | | | Comparative | | |
|---|---|---|---|---|---|---|---|
| | 1 | No. 1 | No. 2 | No. 3 | 2 | No. 4 | No. 5 |
| DESMODUR N 3300 (Bayer AG, D) | 16.4 | | | | | | |
| VESTANAT 1890 L (Degussa AG, D) | | | | | 28.4 | | |
| Crosslinker component B from Example I | | | | | | 33.9 | 33.3 |
| Crosslinker component B from Example II | | 24.6 | | 24.6 | | | |
| Crosslinker component B from Example III | | | 23.7 | | | | |
| SYNTHALAN HS 86B (Synthopol-Chemie, D) | | | | | 46.2 | 41.1 | 40.4 |
| MACRYNAL SM 510 N (Vianova Resins, A) | 52.3 | 43.5 | 44.8 | 48.0 | | | |
| DBTL | 0.005 | 0.01 | 0.005 | 0.01 | 0.03 | 0.03 | 0.03 |
| DYNAPOL catalyst 1203 (Degussa, D) | | 1.4 | 1.4 | 1.4 | | | 1.7 |
| TINUVIN 292 (Ciba, Ch) | 0.24 | 0.23 | 0.23 | 0.23 | 0.29 | | |
| TINUVIN 900 (Ciba, Ch) | 0.24 | 0.23 | 0.23 | 0.23 | 0.29 | | |
| Butyl acetate | 12.8 | 12.4 | 12.2 | 12.3 | 10.0 | 18.6 | 18.2 |
| Xylene | 12.8 | 12.4 | 12.2 | 12.3 | 6.6 | | |
| Dibasic ester | 5.0 | 5.0 | 5.0 | 2.0 | | | |
| Butyl glycol acetate | | | | | 3.0 | 5.0 | 5.0 |
| FLUORAD FC 430 (3M, U.S.A.) | 0.2 | 0.2 | 0.2 | 0.2 | | | |
| BYK 333 (BYK-Chemie, D) | | | | | 0.2 | 0.2 | 0.2 |
| BYK Spezial (BYK-Chemie, D) | | | | | 5.0 | 1.2 | 1.2 |

2K clearcoat materials were formulated in accordance with the quantities indicated in Table 1. The viscosity determined as the efflux time in the DIN-4 cup at 23° C., was about 20 seconds.

In order to test the scratch resistance, the clearcoat materials were sprayed in a wet-on-wet process to a black basecoat (Permacron, Spies Hecker, spray application, 10-minute flashoff time at ambient temperature). Curing was carried out after 5 minutes' flashoff time at 140° C. for 25 minutes. The dry film thickness of the clearcoats was about 35 μm. After storage at ambient temperature for 14 d, the scratch resistance was measured.

In order to assess the acid resistance, clearcoat materials were applied by the above process to a silver-metallic basecoat (STANDOX VWL 97A, diamond silver, from Herberts) on gradient oven panels (BYK-Gardner), and cured.

Mechanical properties and general resistance properties were analyzed on single-coat clearcoat materials, applied to phosphatized steel panels (Bonder 26) and cured at 140° C. for 25 minutes.

Test for Scratch Resistance:

A 45 mm×20 mm nylon fabric, mesh size 31 μm, is loaded with a 2 kg weight, placed on the test panel, which is itself fixed on a slider, and locked in place. Following the application of 1 ml of a stirred up 0.25% strength laundry detergent solution (Persil) immediately in front of the test area, the test panel is oscillated with a maximum deflection of about 3.5 cm in each case. After 80 double strokes (1 s⁻¹), the remaining detergent liquid is rinsed off with tap water and the panel is dried using compressed air. Before and after each test, gloss measurements (20° angle) are made.

Recovery (reflow) under the effect of temperature: The damaged test panel is stored in a forced air oven at 60° C. for 2 h and then the gloss of the coating is measured again.

Test for Acid Resistance:

Using a pipette, drops (about 0.25 ml) of 20% strength sulfuric acid solution are applied to the metal test panels at a distance of 2 cm. In a temperature gradient oven (BYK-Gardner), the panels are subjected to a temperature gradient of 35-80° C. in the lengthwise direction of the panel for 30 minutes. Residues of the acid are then washed off with water and, after 24 h, the panels are subjected to visual examination. In order to assess the resistance, the region (temperature) of first visible attack of the clearcoat, and the region of destruction of the basecoat, are reported, in ° C. The higher the respective temperature, the higher the evaluated resistance of the clearcoat.

TABLE 2
Mechanical characteristics and resistance properties of clearcoats

| | Example | | | | | | |
|---|---|---|---|---|---|---|---|
| | Comparative | | | | Comparative | | |
| | 1 | No. 1 | No. 2 | No. 3 | 2 | No. 4 | No. 5 |
| Film thickness (μm) | 40 | 35 | 35 | 30 | 45 | 30 | 30 |
| König hardness (s) | 195 | 190 | 193 | 189 | 160 | 132 | 160 |
| Erichsen cupping (mm) | 7.0 | 6.0 | 5.0 | 7.0 | 7.5 | 8.0 | 5.0 |
| Super-grade gasoline resistance | very | very | very | very | very | very | very |
| | good | good | good | good | good | good | good |
| MEK wipe resistance | >150 | >150 | >150 | >150 | >150 | >150 | >150 |
| (double strokes) | | | | | | | |
| Acid resistance: | | | | | | | |
| Clearcoat attack at ° C. | 53 | 50 | 47 | 50 | 56 | 46 | 47 |
| Basecoat destruction at ° C. | 66 | 60 | 61 | 63 | 72 | 62 | 75 |
| Scratch resistance: | | | | | | | |
| Initial gloss, 20° | 85.2 | 87.7 | 88.1 | 86.9 | 78.8 | 80.5 | 82.4 |
| Gloss difference after test, 20° | 30.5 | 17.6 | 12.0 | 15.8 | 59.3 | 56.9 | 20.5 |
| Difference from initial gloss after | 19.4 | 10.6 | 7.7 | 8.6 | 12.7 | 15.8 | 5.6 |
| reflow (60° C.), 20° | | | | | | | |

The cured clearcoats exhibit a highly comparable profile of mechanical properties and also comparable general resistance properties.

Despite the lower OH:NCO ratio of 1.0:0.8, the clearcoats of Examples 1 and 2 exhibit similar mechanical data and only a slightly lower acid resistance than the comparative example 1 (OH:NCO=1.0:1.0), while having much-improved scratch resistance and significantly improved reflow behavior. Comparison of Examples 1 and 2 shows that both N,N-bis(3-triethoxysilylpropyl)amine (Example 1) and N,N-bis(3-trimethoxysilylpropyl)amine (Example 2) can be used.

Example 3 shows that, even at an OH:NCO ratio of 1.0:0.6, the profile of properties achieved is as good as that in Examples 1 and 2.

The clearcoat of Example 5, despite the lower OH/NCO ratio of 1.0:0.8, exhibits similar mechanical data and only a slightly lower acid resistance than the comparative example 2 (OH:NCO-1.0:1.0), while having much-improved scratch resistance and significantly improved reflow behavior.

Example 4 shows the positive influence of an additional sulfonic acid catalyst at an OH/NCO ratio of 1.0:0.8.

The disclosure of priority German application 10132938.5, filed Jul. 6, 2001, is hereby incorporated by reference.

1. A nonaqueous thermosetting two-component coating composition comprising
A) a solvent-containing polyol component and
B) a crosslinker component, comprising at least one aliphatic and/or cycloaliphatic polyisocyanate having an NCO functionality of 2-6, from 0.1 to 95 mol % of isocyanate groups originally present as free isocyanate groups of the polyisocyanate having undergone reaction with at least one N,N-bis(3-trialkoxysilylpropyl)amine,
in a weight ratio A) to B) of from 6:1 to 1:2, based on nonvolatile organic constituents.

2. The nonaqueous thermosetting two-component coating composition as claimed in claim 1, wherein polyol component A) is at least one selected from the group consisting of hydroxyl-containing (meth)acrylic copolymers, saturated polyester polyols, polycarbonate diols, polyether polyols, and polyols containing urethane groups and ester groups.

3. The nonaqueous thermosetting two-component coating composition as claimed in claim 2, wherein polyol component A) is at least one hydroxyl-containing (meth)acrylic copolymer having a number-average molar weight from 2 000 to 20 000 g/mol, a glass transition temperature of from −40 to +60° C., and a hydroxyl content of from 70 to 250 mg KOH/g, based on nonvolatile constituents.

4. The nonaqueous thermosetting two-component coating composition as claimed in claim 2, wherein polyol component A) is at least one polyester polyol having an average functionality of from 2.0 to 4.0 and a number-average molar weight of from 500 to 5 000 g/mol.

5. The nonaqueous thermosetting two-component coating composition as claimed in claim 2, wherein polyol component A) is at least one polyol containing urethane groups and ester groups, and prepared from at least one of HDI, IPDI, TMDI and H₁₂-MDI, and having a number-average molar weight of from 500 to 2 000 g/mol.

6. The nonaqueous thermosetting two-component coating composition as claimed in claim 1, wherein the polyisocyanate of the crosslinker component B is prepared from at least one of the following diisocyanates: HDI, IPDI, H₁₂-MDI, TMXDI, 1,3-H-XDI, TMDI, MPDI, NBDI, LTI and NTI.

7. The nonaqueous thermosetting two-component coating composition as claimed in claim 6, wherein the crosslinker component B) comprises at least one polyisocyanate obtained by trimerization, dimerization, urethane formation, biuret formation or allophanate formation.

8. The nonaqueous thermosetting two-component coating composition as claimed in claim 6, wherein the crosslinker component B) comprises a mixture of at least one polyisocyanate and at least one monomeric diisocyanate.

9. The nonaqueous thermosetting two-component coating composition as claimed in claim 6, wherein the polyisocyanate is additionally chain-extended or branched.

10. The nonaqueous thermosetting two-component coating composition as claimed in claim 6, wherein the N,N-bis(3-trialkoxysilylpropyl)amine has the following formula
NH((CH₂)₃—Si(OR¹OR²OR³))₂ (I)
wherein R¹, R² and R³ simultaneously or independently of one another are an alkyl group or isoalkyl group having 1-8 carbon atoms.

11. The nonaqueous thermosetting two-component coating composition as claimed in claim 10, wherein the N,N-bis(3-trialkoxysilylpropyl)amine is at least one of
N,N-bis(3 -trimethoxysilylpropyl)amine,
N,N-bis(3-triethoxysilylpropyl)amine, and
N,N-bis(3-triisopropoxysilylpropyl)amine.

12. The nonaqueous thermosetting two-component coating composition as claimed in claim 1, which additionally contains at least one solvent or auxiliary.

13. The nonaqueous thermosetting two-component coating composition as claimed in claim 12, wherein at least one auxiliary is present and is selected from the group consisting of stabilizers, catalysts, leveling agents, rheological aids, microgels, pigments and pyrogenic silica.

14. The nonaqueous thermosetting two-component coating composition as claimed in claim 13, wherein at least one catalyst is present and is selected from the group consisting of organic Sn(IV), Sn(II), Zn and Bi compounds, and tertiary amines.

15. The nonaqueous thermosetting two-component coating composition as claimed in 13, wherein at least one catalyst is present and is selected from the group consisting of sulfonic acid-based catalysts in latent form, sulfonic acid-based catalysts as amine-neutralized components, sulfonic acid-based catalysts as covalent adducts with epoxide-containing compounds, aluminum titanates, aluminum chelates, and zirconium chelates.

16. The nonaqueous thermosetting two-component coating composition as claimed in claim 1,
wherein at least one catalyst is present and in an amount of 0.01-0.5% by weight, based on nonvolatile organic constituents, and is selected from the group consisting of organic Sn(IV), Sn(II), Zn and Bi compounds, and tertiary amines, and
wherein at least another catalyst is present and in an amount of 0.1-7% by weight, based on nonvolatile organic constituents, and is selected from the group consisting of sulfonic acid-based catalysts in latent form, sulfonic acid-based catalysts as amine-neutralized components, sulfonic acid-based catalysts as covalent adducts with epoxide-containing compounds, aluminum titanates, aluminum chelates, and zirconium chelates.

17. The nonaqueous thermosetting two-component coating composition as claimed in claim 13,
wherein at least one catalyst is present and in an amount of 0.01-0.5% by weight, based on nonvolatile organic constituents, and is selected from the group consisting of organic Sn(IV), Sn(II), Zn and Bi compounds, and tertiary amines, and
wherein at least another catalyst is present and in an amount of 0.1-7% by weight, based on nonvolatile organic constituents, and is selected from the group consisting of sulfonic acid-based catalysts in latent form, sulfonic acid-based catalysts as amine-neutralized components, sulfonic acid-based catalysts as covalent adducts with epoxide-containing compounds, aluminum titanates, aluminum chelates, and zirconium chelates.

18. The nonaqueous thermosetting two-component coating composition as claimed in claim 1, wherein the N,N-bis(3-trialkoxysilylpropyl)amine has the following formula
NH((CH₂)₃—Si(OR¹OR²OR³))₂ (I)
wherein R¹, R² and R³ simultaneously or independently of one another are an alkyl group or isoalkyl group having 1-8 carbon atoms.

19. The nonaqueous thermosetting two-component coating composition as claimed in claim 18, wherein the N,N-bis(3-trialkoxysilylpropyl)amine is at least one of
N,N-bis(3-trimethoxysilylpropyl)amine,
N,N-bis(3-triethoxysilylpropyl)amine, and
N,N-bis(3-triisopropoxysilylpropyl)amine.

20. A method comprising coating the nonaqueous thermosetting two-component coating composition as claimed in claim 1 on a substrate, and curing the coating.
